(19) United States
(12) Patent Application Publication
(10) Pub. No.: US 2011/0261500 A1
(43) Pub. Date: Oct. 27, 2011

(54) BACK END OF LINE METAL-TO-METAL CAPACITOR STRUCTURES AND RELATED FABRICATION METHODS

(75) Inventors: Patrice M. Parris, Phoenix, AZ (US); Richard J. De Souza, Chandler, AZ (US); Weize Chen, Phoenix, AZ (US); Moaniss Zitouni, Queen Creek, AZ (US)

(73) Assignee: FREESCALE SEMICONDUCTOR, INC., Austin, TX (US)

(21) Appl. No.: 12/765,575

(22) Filed: Apr. 22, 2010

(51) Int. Cl. H01G 4/00; B05D 5/12

(52) U.S. Cl. 361/301.1; 427/79

(57) ABSTRACT

Apparatus and related fabrication methods are provided for capacitor structures. One embodiment of a capacitor structure comprises a plurality of consecutive metal layers and another metal layer. Each via layer of a plurality of via layers is interposed between metal layers of the plurality of metal layers. The plurality of metal layers and the plurality of via layers are cooperatively configured to provide a first plurality of vertical conductive structures corresponding to a first electrode and a second plurality of vertical conductive structures corresponding to a second electrode. The plurality of consecutive metal layers form a plurality of vertically-aligned regions and provide intralayer electrical interconnections among the first plurality of vertical conductive structures. The first metal layer provides an intralayer electrical interconnection among the second plurality of vertical conductive structures, wherein each vertically-aligned region has a vertical conductive structure of the second plurality of vertical conductive structures disposed therein.

### TECHNICAL FIELD

Embodiments of the subject matter described herein relate generally to electronic devices, and more particularly, embodiments of the subject matter relate to structures for back end of line (BEOL) capacitors.

### BACKGROUND

Many integrated circuits include one or more integrated capacitors that are often utilized for analog applications. Often, it is desirable that the capacitance of these integrated capacitors be relatively constant over the anticipated voltage range (i.e., linear capacitors).

Some modern deep sub-micron processes utilize metal-insulator-metal (MIM) capacitors. However, because thin dielectric layers are employed to improve the capacitance density, they are typically not rated for higher voltage use. Additionally, these MIM capacitor structures require additional processing steps, which increase manufacturing costs. To avoid the added process costs, the metal and dielectric layers that are part of the existing back end of line (BEOL) fabrication process may be used to create integrated linear metal-to-metal (MtM) capacitors. The existing BEOL dielectric layers are typically thicker than the dielectric layers used in MIM capacitors, and as a result, the capacitance density of BEOL MtM capacitors is generally lower than MIM capacitors. Additionally, BEOL fabrication processes may utilize a dielectric material having a lower dielectric constant (a low-k dielectric) which further reduces the capacitance density of BEOL MtM capacitors.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a top view of an exemplary embodiment of a metal layer suitable for use as one or more lower metal layers in a capacitor structure in accordance with one embodiment of the invention;

FIG. 2 is a top view of an exemplary embodiment of a via layer suitable for use with the metal layer of FIG. 1 in a capacitor structure in accordance with one embodiment of the invention;

FIG. 3 is a top view of the via layer of FIG. 2 overlying the metal layer of FIG. 1 in accordance with one embodiment of the invention;

FIG. 4 is a top view of a metal layer suitable for use as the upper metal layer of a capacitor structure in accordance with one embodiment of the invention;

FIG. 5 is a cross-sectional view of the metal layers and via layers of FIGS. 1-4 along the line 5-5 for a capacitor structure in accordance with one embodiment of the invention;

FIG. 6 is a cross-sectional view of the metal layers and via layers of FIGS. 1-4 along the line 6-6 for a capacitor structure in accordance with one embodiment of the invention;

FIG. 7 is a top view of an exemplary embodiment of a via layer suitable for use with the metal layer of FIG. 1 in a capacitor structure in accordance with one embodiment of the invention;

FIG. 8 is a cross-sectional view of a capacitor structure in accordance with one embodiment of the invention using the via layer of FIG. 7 as lower via layers, wherein FIG. 8 is representative of a cross-section of the metal layers and via layers of FIGS. 1-5 along the line 5-5 and the via layer of FIG. 7 along the line 8-8;

FIG. 9 is a top view of an exemplary embodiment of a metal layer suitable for use as one or more lower metal layers in a capacitor structure using the via layer of FIG. 7 as lower via layers in accordance with one embodiment of the invention;

FIG. 10 is a top view of an exemplary embodiment of a metal layer suitable for use as the upper metal layer of a capacitor structure in accordance with one embodiment of the invention;

FIG. 11 is a top view of an exemplary embodiment of a via layer suitable for use with the metal layer of FIG. 10 in a capacitor structure in accordance with one embodiment of the invention;

FIG. 12 is a cross-sectional view of a capacitor structure in accordance with one embodiment of the invention using the metal layer of FIG. 1 as lower metal layers, the via layer of FIG. 7 as lower via layers, the via layer of FIG. 11 as the upper via layer, and the metal layer of FIG. 10 as the upper metal layer, wherein FIG. 12 is representative of a cross-section of the metal layer of FIG. 1 along the line 5-5, the via layer of FIG. 7 along the line 8-8, and the metal layer of FIG. 10 and the via layer of FIG. 11 along the line 12-12; and

FIG. 13 is a flow diagram of an exemplary fabrication process suitable for use in forming a capacitor structure in accordance with one embodiment of the invention.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Technologies and concepts discussed herein relate to back end of line (BEOL) Metal-to-Metal (MtM) capacitors that achieve relatively high capacitance density and relatively low series resistance as well as relatively low parasitic capacitance between one electrode and the underlying semiconductor substrate. As described in greater detail below, metal layers and via layers are arranged to provide vertical conductive structures corresponding to electrodes of the capacitor. In an exemplary embodiment, a plurality of consecutive metal layers (e.g., the lower metal layers) are configured to provide intralayer electrical interconnections among a first subset of the vertical conductive structures corresponding to a first electrode (e.g., the A electrode) of the capacitor. Another metal layer (e.g., the upper metal layer) is configured to provide an intralayer electrical interconnection among a second subset of the vertical conductive structures corresponding to the second electrode (e.g., the B electrode) of the capacitor. The intralayer electrical interconnections formed by the consecutive metal layers result in vertically-aligned regions, wherein vertical conductive structures corresponding to the B electrode are disposed within the vertically-aligned regions to achieve higher intralayer capacitance. As a result, the capacitor structure provides high intralayer interconnectivity for one electrode (e.g., the A electrode) and intralayer interconnectivity for the other electrode at one metal layer (e.g., the upper metal layer), which reduces the series resistance of the capacitor structure while achieving relatively high intralayer capacitance density. Additionally, the B electrode has a low parasitic capacitance to the underlying semiconductor substrate when it is interconnected by the upper metal layer. All BEOL metal and via layers may be used for the capacitor structure, which increases capacitance density of the BEOL capacitor structure and decreases the area penalty when the inter-electrode spacing is scaled for higher voltages. Further embodiments may employ via layers that maximize intralayer capacitance of the vias by arranging vertical faces of vias corresponding to one electrode (e.g., the A electrode) substantially parallel to vertical faces of adjacent vias corresponding to the opposite electrode (e.g., the B electrode).

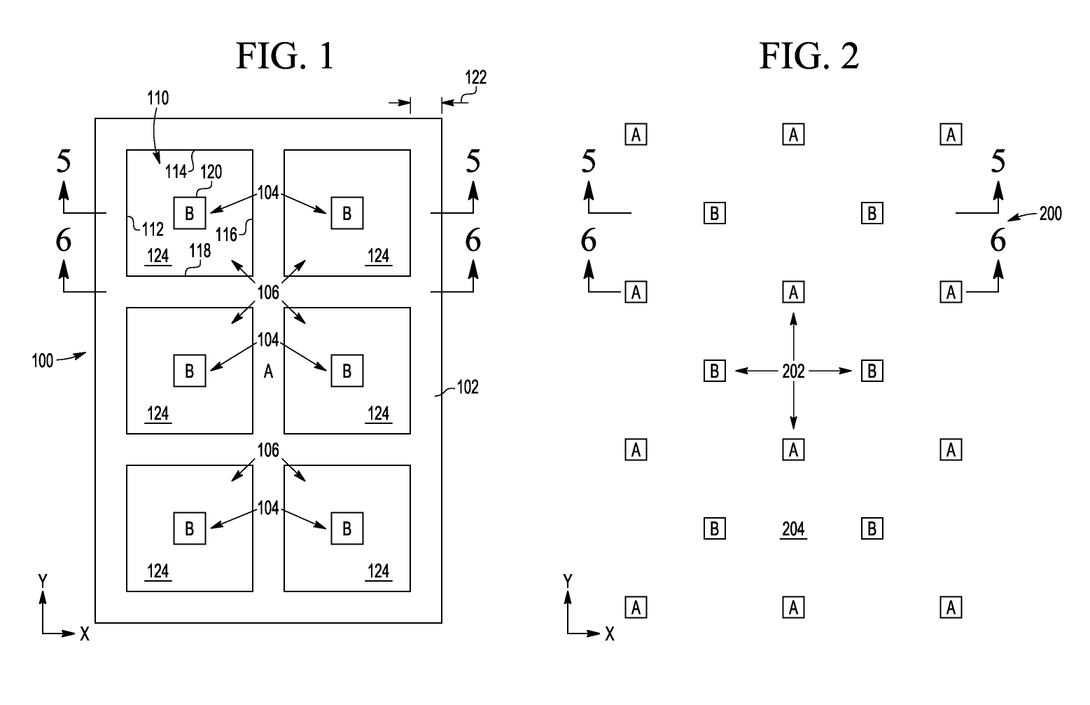

It will be appreciated that the general shape and area of the BEOL capacitor structure will vary depending on the needs of a particular embodiment. Furthermore, it will be appreciated that FIGS. 1-12 are representative of only a portion of the total area occupied by the metal layers and via layers, and in practice, the remaining portions of the metal layers and via layers that are not illustrated may be utilized to form connections to and/or interconnections among circuit elements formed on an underlying semiconductor substrate. In practice, the metal layers and via layers will also include dielectric material that provide electrical isolation between portions of metal and/or vias that are not in direct contact with another metal and/or via. The presence of this dielectric material is well known, and accordingly, for ease of illustration and explanation, this dielectric material is not shown in each of FIGS. 1-12. Additionally, it should be appreciated that although the subject matter may be described herein in the context of a capacitor structure comprising five metal layers and four intervening via layers, practical embodiments may utilize any number of metal layers and via layers to realize a capacitor structure suitable for a particular application. Accordingly, the subject matter described herein is not limited to a particular number of metal layers and/or via layers.

FIGS. 1-6 depict top views and cross-sectional views of an arrangement of metal layers and via layers of a BEOL MtM capacitor structure in accordance with one embodiment of the invention. Various steps in the fabrication of BEOL MtM capacitor structures are well known and so, in the interest of brevity, many conventional steps will only be mentioned briefly herein or will be omitted entirely without providing the well known process details.

FIG. 1 depicts a top view of an exemplary embodiment of a metal layer 100 suitable for use as one or more lower metal layers (e.g., Metal Layers 1 through 4) in the BEOL capacitor structure of FIGS. 1-6. As used herein, a lower metal layer should be understood as referring to a metal layer that underlies one or more other metal layers of the capacitor structure. As shown, in an exemplary embodiment, the metal layer 100 comprises a metallization pattern 102 and a plurality of metal landings 104. As described in greater detail below, the metallization pattern 102 corresponds to the material of the metal layer 100 that forms part of a first electrode (the A electrode) of a capacitor structure, and the metal landings 104 correspond to the material of the metal layer 100 that forms part of a second electrode (the B electrode) of the capacitor structure.

In an exemplary embodiment, the metallization pattern 102 and the metal landings 104 are formed from a conductive metal material, such as copper or aluminum. For example, for the lowest metal layer (e.g., Metal Layer 1) of the BEOL capacitor structure of FIGS. 1-6, a layer of conductive material (e.g., copper or aluminum) may be conformably deposited overlying an interlayer dielectric (which overlies a semiconductor substrate) and portions of the conductive material may be selectively removed (e.g., by patterning and etching) resulting in the metallization pattern 102 and metal landings 104. Alternatively, a layer of dielectric material may be formed and etched to form trenches and/or holes that are subsequently filled by depositing a conductive material (e.g., copper, aluminum, or tungsten) in the trenches and/or holes, resulting in the metallization pattern 102 and metal landings 104.

As described in greater detail below, the metallization pattern 102 and metal landings 104 function as via landing areas for contacting vias overlying and/or underlying the metal layer 100. In this regard, the metallization pattern 102 functions as a conductive trace that provides an intralayer (e.g., across metal layer 100 or in the xy-reference plane) electrical interconnection among vias that are in contact with the metallization pattern 102. In an exemplary embodiment, the width 122 of the metallization pattern 102 satisfies any applicable layout and/or spacing rules (e.g., minimum metal width) for the metal layer 100. The width 122 of the metallization pattern 102 may be less than about 0.25 micrometers (or microns). The metal landings 104 are spaced apart (or physically separated) from the metallization pattern 102 to satisfy layout and/or spacing rules (e.g., minimum metal to metal spacing) for the metal layer 100. For example, as shown in FIG. 1, the metal landings 104 and the metallization pattern 102 are physically separated, wherein the void or space between the metallization pattern 102 and the metal landings 104 may be occupied by a dielectric material 124. The dielectric material 124 may be part of the formation of the metal layer 100 as described above, or may comprise a dielectric material subsequently formed overlying the metal layer 100 (e.g., dielectric material 204 described below in the context of FIG. 2) which fills the spaces between metallization pattern 102 and metal landings 104. In an exemplary embodiment, the lateral (or cross-sectional) area of each metal landing 104 corresponds to the minimum metal size in the xy-reference plane based on the cross-sectional dimensions of the underlying and/or overlying vias while accounting for any applicable minimum metal width (or minimum metal area) rules for the metal layer 100 or any rules for the minimum metal overlap of the vias. In this regard, the cross-sectional area of the metal landings 104 in the xy-reference plane is greater than or equal to the cross-sectional area of any vias that overlie and/or underlie the metal landings 104 and are aligned with the metal landings 104 in the z-direction.

As shown in FIG. 1, the metallization pattern 102 forms one or more enclosed regions 106 that are circumscribed in the xy-reference plane by the metallization pattern 102, wherein a metal landing 104 of the plurality of metal landings 104 is disposed within the interior of each enclosed region 106. In the illustrated embodiment, the metallization pattern 102 forms a plurality of quadrilateral-shaped regions 106, however, the subject matter is not intended to be limited to any particular shape for the regions formed by the metallization pattern 102. The metal landings 104 disposed within the quadrilateral-shaped regions 106 are spaced from the edges of the quadrilateral-shaped regions 106 by a distance greater than or equal to the minimum metal-to-metal spacing for the metal layer 100. The dimensions of the metal landings 104 and the spacing between the metal landings 104 and the metallization pattern 102 may be chosen to achieve a maximum capacitive coupling between the metal landings 104 and the metallization pattern 102 to increase the intralayer capacitance density of the metal layer 100. For some embodiments, the metal landings 104 are disposed at or near the geometric center of the quadrilateral-shaped regions 106. For example, as shown in FIG. 1, in accordance with one or more embodiments, the quadrilateral-shaped regions 106 formed by the metallization pattern 102 may comprise squares (or regular quadrilaterals), wherein the metal landings 104 are disposed at the geometric center of the interior of the square regions. In alternative embodiments, there may be more than one metal landing 104 disposed within each region 106 formed by metallization pattern 102.

FIG. 2 depicts a top view of an exemplary embodiment of a via layer 200 suitable for use with the metal layer 100 of FIG. 1 as a via layer (e.g., Via Layers 1 through 4) in the BEOL capacitor structure of FIGS. 1-6. As shown, in an exemplary embodiment, via layer 200 comprises a plurality of vias 202 which are interposed in a dielectric material (e.g., an interlayer dielectric) that provides physical separation and electrical isolation between adjacent BEOL metal layers. The vias 202 may be formed in a conventional manner, for example, by forming a layer of dielectric material overlying a metal layer (e.g., metal layer 100), patterning and etching holes in the layer of dielectric material, forming conductive material (e.g., copper, aluminum, tungsten, or the like) in the holes in the dielectric material, and planarizing the upper surface of the conductive material and/or dielectric material, resulting in vias 202. It should be noted that the dielectric material will fill any spaces (e.g., the spaces between metallization pattern 102 and metal landings 104) in the underlying metal layer. In this manner, the metal landings 104 are electrically isolated from the metallization pattern 102 and the metal landings 104 are not electrically interconnected at metal layer 100. As shown in FIG. 2, in an exemplary embodiment, the vias 202 have a substantially square cross-sectional area in the xy-reference plane, however, in practice, the vertices of the squares may be rounded due to effects of photolithography and/or etch processes. In other embodiments, the cross-sectional shape of the vias 202 in the xy-reference plane may be rectangular, circular, triangular, or have another geometric shape suitable for the particular application.

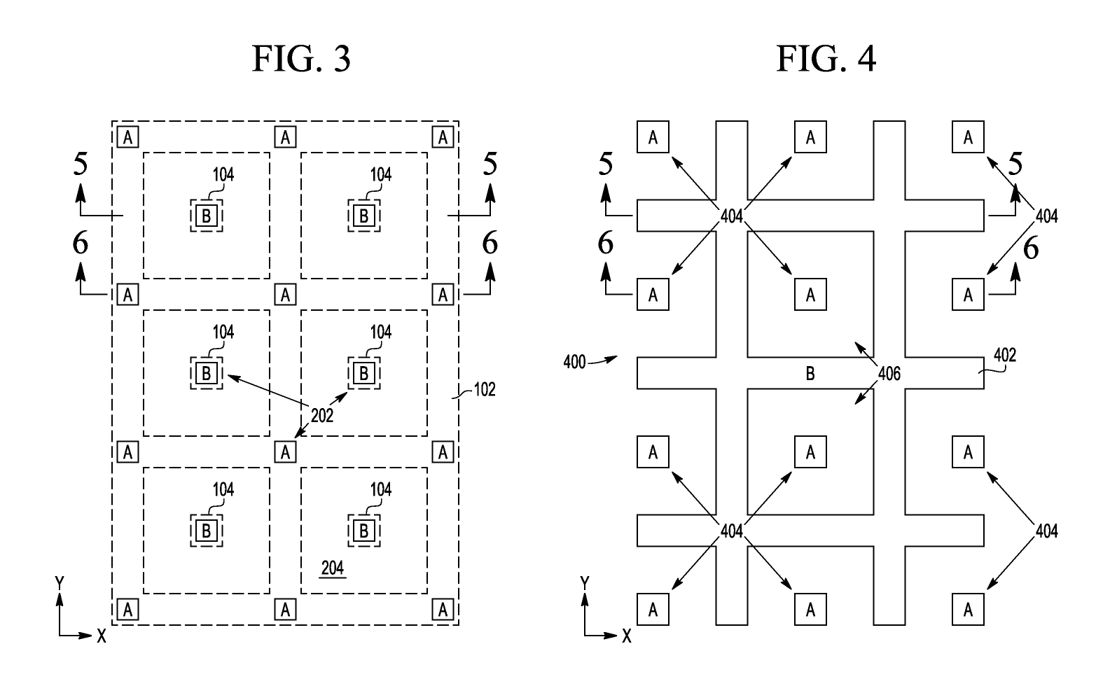

In an exemplary embodiment, the plurality of vias 202 includes a first subset of vias that are vertically-aligned (e.g., in the z-direction) with material of the overlying and/or underlying metal layer corresponding to the first electrode (e.g., the A electrode) of the capacitor structure, and a second subset of vias that are vertically-aligned with material of the overlying and/or underlying metal layer corresponding to the second electrode (e.g., the B electrode) of the capacitor structure. For example, FIG. 3 depicts a top view of the via layer 200 of FIG. 2 overlying the metal layer 100 of FIG. 1. As described above, the metallization pattern 102 provides an intralayer electrical interconnection between a first subset of vias 202 that are overlying and in contact with the metallization pattern 102 to provide a first electrode (e.g., the A electrode) of a capacitor formed by the BEOL capacitor structure. Accordingly, for convenience, but without limitation, the subset of vias 202 that are in contact with the metallization pattern 102 may alternatively be referred to herein as the A subset of vias 202 (or the A vias). As shown, each metal landing 104 functions as a via landing area for a via of a second subset of vias 202 that are overlying and in contact with the respective metal landing 104 to provide the second electrode (the B electrode) of the capacitor formed by the BEOL capacitor structure. Accordingly, for convenience, but without limitation, the subset of vias 202 that are in contact with the metal landings 104 may alternatively be referred to herein as the B subset of vias 202 (or the B vias).

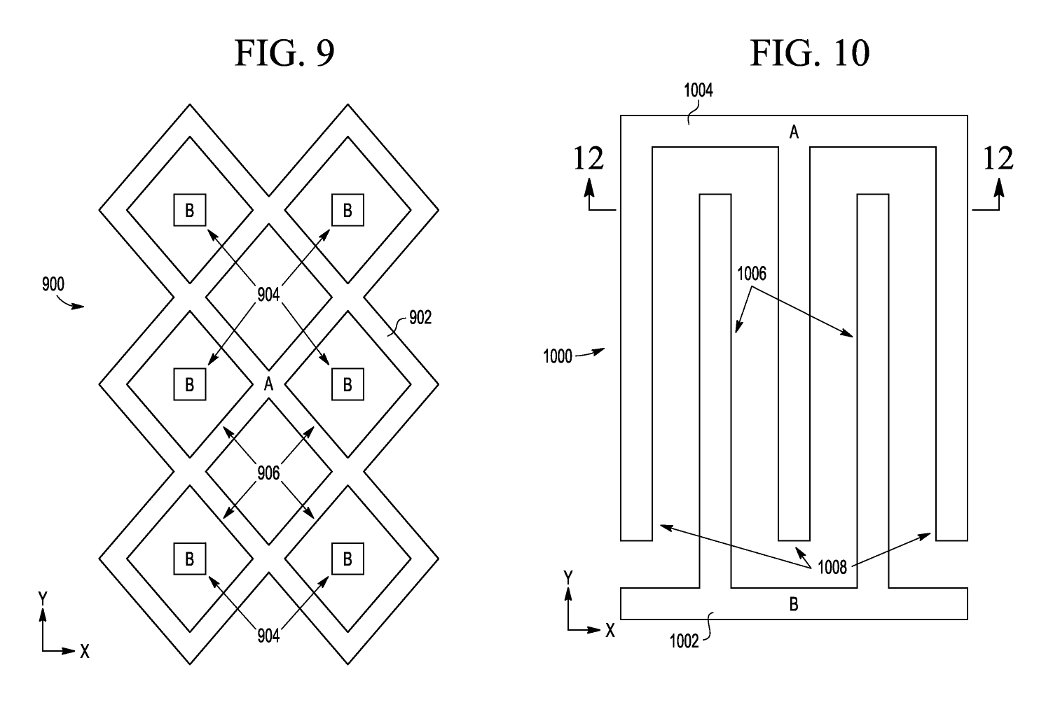

Still referring to FIGS. 1-3, in the illustrated embodiment, the vias 202 of the via layer 200 are arranged such that the A subset of vias 202 includes a via vertically-aligned with each vertex (or corner) of a respective quadrilateral-shaped region 106 formed by the metallization pattern 102. In other words, in an exemplary embodiment, each vertex of each respective quadrilateral-shaped region 106 has an A via overlying and/or underlying it in the z-direction. In the illustrated embodiment, the metallization pattern 102 provides an interconnection between the A subset of vias 202 at the vertices of the quadrilateral-shaped regions 106, resulting in the interior angles of the quadrilateral-shaped regions 106 being substantially equal to 90°. In other embodiments, the interior angles of the quadrilateral-shaped regions 106 may be different from 90°, as described in greater detail below in the context of FIG. 9. In a similar manner, the vias 202 of the via layer 200 are arranged such that a B via is aligned with each metal landing 104 in the z-direction. It should be noted that, although not illustrated in FIG. 2, if spacing and layout rules for the lower via layers allow for additional vias in via layer 200, the via layer 200 may be modified to include additional A vias vertically-aligned with the metallization pattern 102 and/or include more than one B via vertically-aligned with a respective metal landing 104 to achieve greater capacitance density for the via layer 200 and provide greater interlayer electrical interconnectivity (and thereby reducing series resistance of the capacitor structure).

FIG. 4 depicts a top view of an exemplary embodiment of a metal layer 400 suitable for use as an upper metal layer in the BEOL capacitor structure of FIGS. 1-6. In this regard, the upper (or uppermost) metal layer should be understood as referring to the metal layer of the BEOL capacitor structure that is farthest from the underlying semiconductor substrate. As shown, in an exemplary embodiment, the metal layer 400 comprises a metallization pattern 402 and a plurality of metal landings 404. The metallization pattern 402 and the metal landings 404 are formed from a conductive metal material in a similar manner as described above in the context of metal layer 100. In an exemplary embodiment, the metal layer 400 is formed overlying a via layer (e.g., via layer 200), wherein the metallization pattern 402 corresponds to the material of the metal layer 400 that provides an intralayer electrical interconnection for the electrode of the capacitor structure that is not interconnected at lower metal layers (e.g., the B electrode). The metal landings 404 provide via landing areas for the other electrode of the capacitor structure that is interconnected at one or more lower metal layers (e.g., the A electrode).

As shown in FIG. 4, the metallization pattern 402 forms one or more enclosed regions 406, wherein a metal landing 404 of the plurality of metal landings 404 is disposed within the interior of each region 406, in a similar manner as described above in the context of FIG. 1. Thus, in the illustrated embodiment, the metal landings 404 are disposed within the quadrilateral-shaped regions 406 and spaced from the edges of the quadrilateral-shaped regions 406 by a distance that satisfies layout and/or spacing rules (e.g., minimum metal-to-metal spacing) for the metal layer 400, and the area of the metal landings 404 in the xy-reference plane satisfies layout and/or sizing rules for via landing areas. Furthermore, the area of the metal landings 404 in the xy-reference plane and the spacing of the metal landings 404 with respect to the metallization pattern 402 may be chosen to improve capacitive coupling between the metal landings 404 and the metallization pattern 402, thereby increasing the intralayer capacitance density of the metal layer 400. As shown, in the illustrated embodiment, the metal landings 404 are disposed at or near the geometric center of the interior of the quadrilateral-shaped regions 406 (e.g., centered within regions 406).

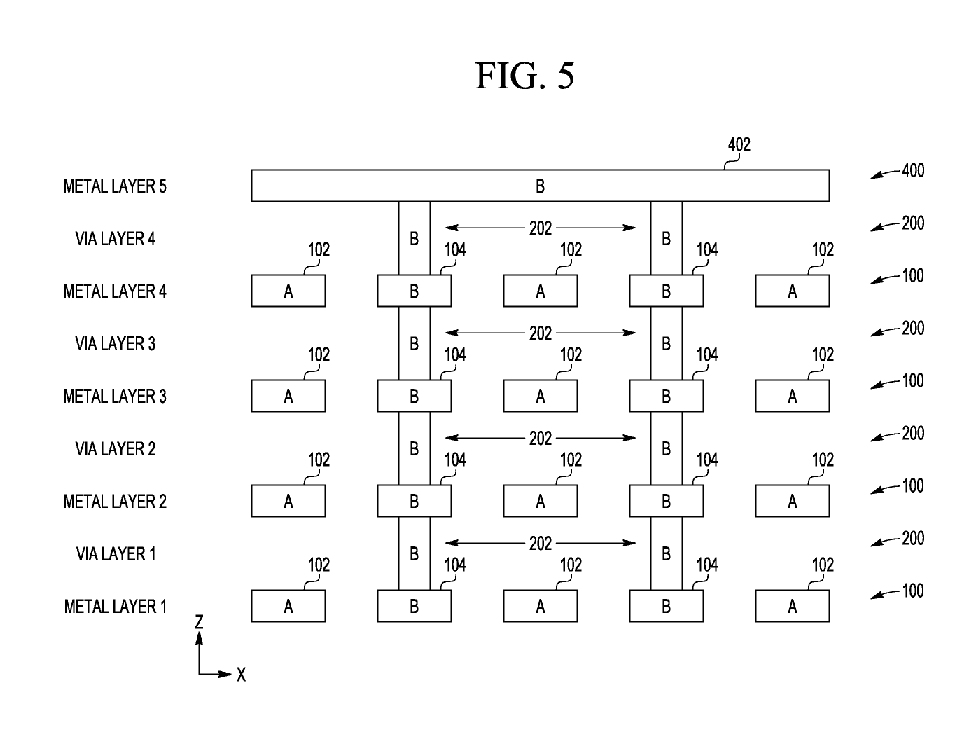

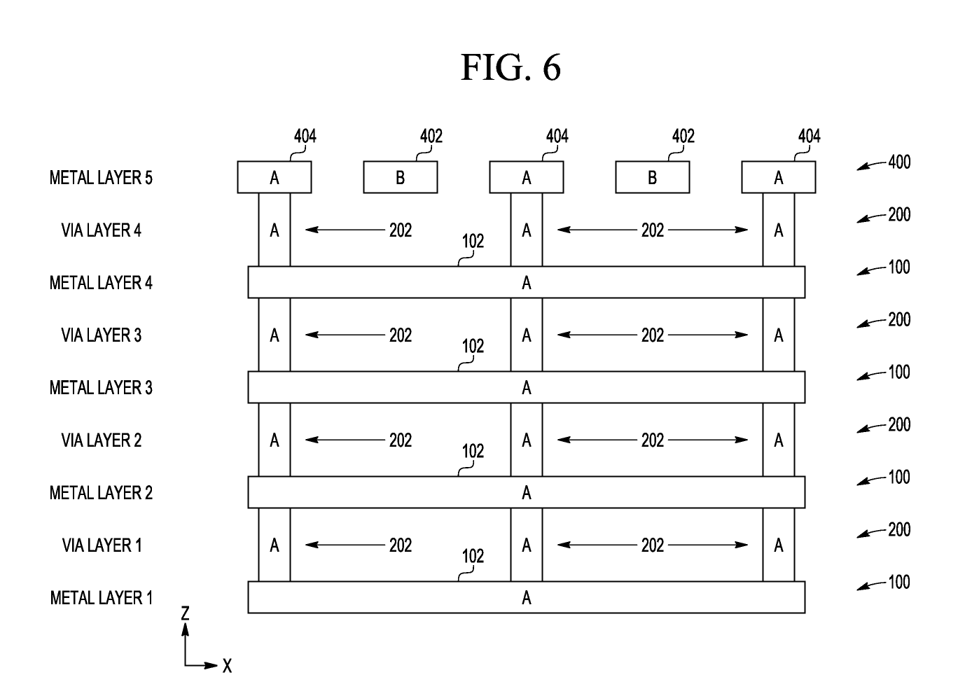

Referring now to FIG. 5 and FIG. 6, and with continued reference to FIGS. 1-4, the arrangement of metal layer 100 underlying via layer 200 may be repeated (or stacked) to provide the lower metal layers and via layers of a BEOL capacitor structure having metal layer 400 as the uppermost metal layer. For example, in the illustrated embodiment, lower Metal Layers 1 through 4 are each realized as metal layer 100, Via Layers 1 through 4 are each realized as via layer 200, and the uppermost Metal Layer 5 is realized as metal layer 400, resulting in the capacitor structure of FIGS. 5 and 6. The lower metal layers are consecutive, that is, in the region of the metal layers corresponding to the BEOL capacitor structure, each metal layer of the lower metal layers has the same arrangement of metallization pattern 102 and metal landings 104 as an adjacent metal layer (e.g., a metal layer separated by a via layer) without an intervening metal layer having a different metal arrangement. The vias 202 of each via layer 200 provide interlayer electrical interconnections among metal layers 100, 400 overlying and/or underlying the respective via layer 200. In an exemplary embodiment, the enclosed regions 106 formed by the metallization patterns 102 of the lower metal layers (e.g., Metal Layers 1 through 4) are vertically-aligned. In other words, the quadrilateral-shaped regions 106 are arranged such that each quadrilateral-shaped region 106 is aligned in the z-direction with a quadrilateral-shaped region 106 of an overlying and/or underlying metal layer. In this manner, the consecutive metal layers form a plurality of vertically-aligned regions.

As best shown by FIG. 5, the alignment of B vias and metal landings 104 in the z-direction creates a plurality of spaced apart vertical conductive structures that are interconnected in the xy-reference plane (i.e., an intralayer electrical interconnection) by the metallization pattern 402 of the upper metal layer (e.g., Metal Layer 5) to form the B electrode of the capacitor. In this regard, the metallization pattern 402 may be used to form a connection to the vertical conductive structures that comprise the B electrode of the capacitor structure, thereby reducing the series resistance of the B electrode. By virtue of the arrangement of the B vias and the metal landings 104 of the lower metal layers, the vertical conductive structures corresponding to the B electrode are disposed within the quadrilateral-shaped regions 106 formed by the lower metal layers, thereby improving the intralayer capacitive couplings between the vertical conductive structures for the B electrode and the surrounding conductive material (e.g., the metallization patterns 102) corresponding to the A electrode.

In the illustrated embodiment, each metal landing 404 of Metal Layer 5 (e.g., the upper metal layer) overlies and is aligned in the z-direction with a vertex of a quadrilateral-shaped region 106 formed by Metal Layer 4 (e.g., the underlying metal layer). Thus, the metal landings 404 are vertically-aligned with the A vias of Via Layers 1-4 (e.g., the underlying via layers). As shown in FIG. 6, the arrangement of the metallization patterns 102 and metal landings 404 and overlying and/or underlying A vias form vertical conductive structures for the A electrode that are interconnected in the xy-reference plane at the lower metal layers (e.g., Metal Layers 1 through 4) of the capacitor structure by metallization pattern 102. As best shown by FIG. 4 and FIG. 6, the vertical conductive structures corresponding to the A electrode are disposed within the quadrilateral-shaped regions 406 formed by the upper metal layer, thereby providing relatively high intralayer capacitive coupling between the vertical conductive structures for the A electrode and the metallization pattern 402 corresponding to the B electrode at the upper metal layer.

As described above, one advantage of the BEOL capacitor structure of FIGS. 1-6 described above is that the arrangement of the metal layers is capable of achieving relatively high intralayer capacitance density while at the same time providing relatively high intralayer interconnectivity for one electrode (e.g., the intralayer interconnections of the A electrode on each of the lower metal layers) and intralayer interconnectivity for the other electrode at the upper metal layer that reduces the series resistance of the capacitor structure. Additionally, the electrode that is not interconnected at the lower metal layers (e.g., the B electrode) has a low parasitic capacitance to the underlying semiconductor substrate because the area in the xy-reference plane of the portion of the B electrode closest to the semiconductor substrate is relatively small (e.g., it consists of only metal landings 104). Furthermore, a metal layer does not need to be dedicated solely to an intralayer electrical interconnection for one electrode (e.g., a plate or sheet of metal dedicated to one electrode). This decreases the area penalty when the inter-electrode spacing is scaled for higher voltages. Thus, the BEOL MtM capacitor structure achieves relatively high capacitance density (or alternatively, relatively low area costs), resulting in a cost-effective BEOL MtM capacitor structure suitable for use in a wider set of applications. When a shield is used between the substrate and the lowest metal layer of the BEOL capacitor structure, the metallization pattern 102 corresponding to the A electrode in the lowest metal layer (e.g., Metal Layer 1) may be electrically connected to the shield.

It should be appreciated that although FIGS. 1-6 are described in the context of the lower metal layers being realized as consecutive metal layers for providing the intralayer interconnections for the A electrode of the capacitor structure and the upper metal layer providing intralayer electrical interconnections for the B electrode of the capacitor structure, other embodiments may utilize the lower metal layer to provide intralayer electrical interconnections for the B electrode of the capacitor structure (e.g., Metal Layer 1 realized as metal layer 400) and the upper metal layers to provide intralayer electrical interconnections for the A electrode of the capacitor structure (e.g., Metal Layers 2-5 realized as metal layer 100). However, the illustrated embodiment of FIGS. 1-6 provides an electrode having relatively low parasitic capacitance that is more readily accessible because the metallization pattern 402 interconnecting that electrode is at a higher metal layer. In some embodiments, consecutive metal layers may be used to form both electrodes of the capacitor structure. For example, the arrangement of metal layer 100 underlying via layer 200 may be repeated (or stacked) to provide lower metal and via layers of a BEOL capacitor structure and metal layer 400 and via layer 200 may be repeated (or stacked) to provide upper metal and via layers of the BEOL capacitor structure. In such embodiments, the enclosed regions 406 formed by the metallization patterns 402 of the consecutive upper metal layers are vertically-aligned, wherein metal landings 404 of the plurality of metal landings 404 are vertically-aligned and disposed within the interior of each region 406, in a similar manner as described above in the context of FIGS. 1-6.

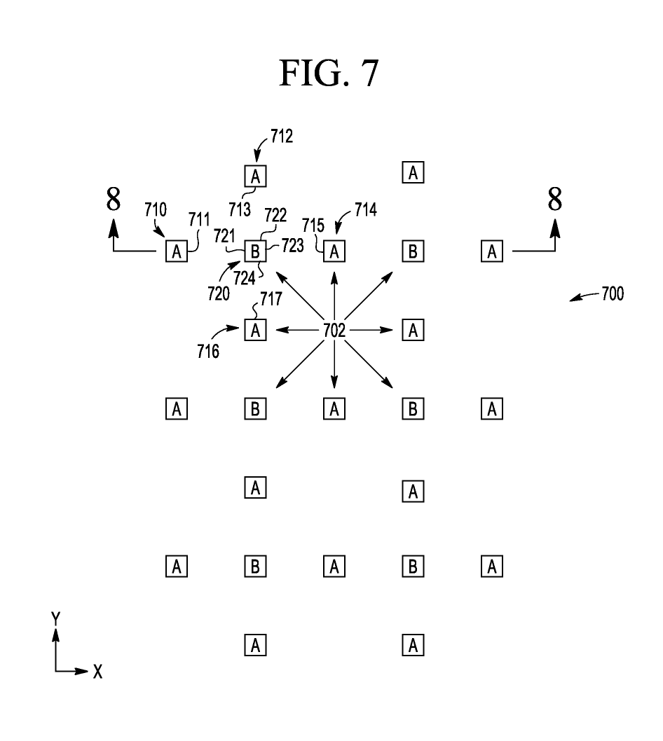

FIG. 7 depicts a top view of an exemplary embodiment of a via layer 700 comprising a plurality of vias 702 suitable for use with the metal layer 100 of FIG. 1 as a lower via layer (e.g., Via Layers 1 through 3) in a BEOL capacitor structure in accordance with one or more embodiments. As used herein, a lower via layer comprises a via layer that has at least one via layer overlying it. Referring now to FIG. 1 and FIG. 7, as described above, the metallization pattern 102 provides an intralayer electrical interconnection between a first subset of the vias 702 (the A subset of vias 702 or the A vias) that are in contact with and underlying and/or overlying the metallization pattern 102. In the illustrated embodiment, the via layer 700 is arranged such that an A via is provided overlying and/or underlying and in contact with each side (or edge) of a respective quadrilateral-shaped region 106 formed by the metallization pattern 102. Thus, the A vias are effectively disposed along the sides (or edges) of the quadrilateral-shaped regions 106. The A vias are arranged such that each via disposed along a side of a quadrilateral-shaped regions 106 is aligned with the nearest B via(s) in either the x-direction or the y-direction.

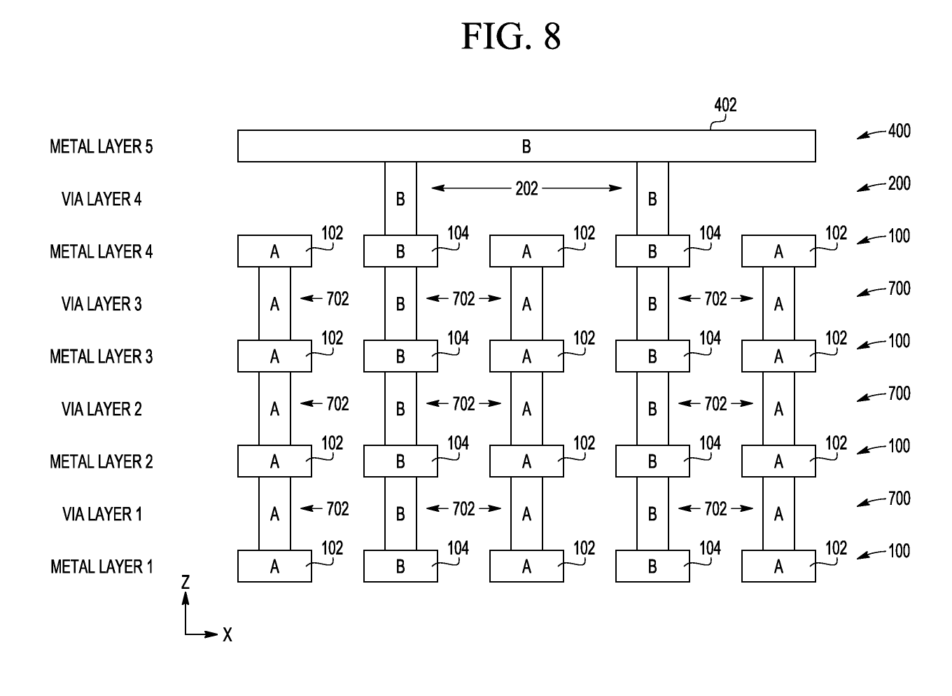

Referring now to FIG. 8, and with continued reference to FIGS. 1-4 and FIG. 7, in accordance with one or more embodiments, the arrangement of the via layer 700 overlying metal layer 100 may be repeated (or stacked) to provide the lower metal layers and lower via layers of a BEOL capacitor structure having metal layer 400 as the uppermost metal layer. For example, in the illustrated embodiment, lower Metal Layers 1 through 4 are realized as metal layer 100, Via Layers 1 through 3 are realized as via layer 700, Via Layer 4 is realized as via layer 200, and the uppermost Metal Layer 5 is realized as metal layer 400, resulting in the capacitor structure of FIG. 8. In this regard, the via layer 200 is used in lieu of via layer 700 between Metal Layer 4 and Metal Layer 5 to ensure electrical isolation between the A and B electrodes and to provide an interlayer electrical interconnection between metallization pattern 402 of Metal Layer 5 and the metal landings 104 of Metal Layer 4 and an interlayer electrical interconnection between metal landings 404 of Metal Layer 5 and vertices of quadrilateral-shaped regions 106 of the metallization pattern 102 of Metal Layer 4. The arrangement of the via layer 700 in conjunction with metal layer 100 results in vertical conductive structures for the A electrode among the lower metal layers (e.g., Metal Layers 1-4) that are disposed along the sides of the vertically-aligned quadrilateral-shaped regions 106 formed by the lower metal layers, and the vertical conductive structures are aligned the vertical conductive structures for the B electrode in either the x-direction or the y-direction.

Still referring now to FIGS. 7 and 8, and with continued reference to FIGS. 1-4, in the illustrated embodiment, the vias 702 are oriented such that the vertical faces (the faces aligned with either the xz-reference plane or the yz-reference plane) of a respective B via are substantially parallel to the vertical faces of the A vias nearest (or adjacent to) that respective B via. As shown, the vertical faces of the A vias disposed along the sides (or edges) of the quadrilateral-shaped regions 106 that face the interior of the quadrilateral-shaped regions 106 are aligned substantially parallel to the outward vertical faces of the B vias that are aligned with the metal landings 104 and disposed in the interior of the quadrilateral-shaped regions 106. In other words, the inward-facing faces of the A vias along the sides of the quadrilateral-shaped regions 106 are substantially parallel to the outward-facing faces of the B vias inside the quadrilateral-shaped regions 106. For example, for a first quadrilateral-shaped region 110, an inward-facing vertical face 711 of a first A via 710 along a first side 112 of the quadrilateral-shaped region 110 is aligned substantially parallel to a first outward-facing vertical face 721 of a B via 720 aligned with a metal landing 120 disposed within the quadrilateral-shaped region 110, an inward-facing vertical face 713 of a second A via 712 along a second side 114 of the quadrilateral-shaped region 110 is aligned substantially parallel to a second outward-facing vertical face 722 of via 720, an inward-facing vertical face 715 of a third A via 714 along a third side 116 of the quadrilateral-shaped region 110 is aligned substantially parallel to a third outward-facing vertical face 723 of via 720, and an inward-facing vertical face 717 of a fourth A via 716 along a fourth side 118 of the quadrilateral-shaped region 110 is aligned substantially parallel to a fourth outward-facing vertical face 724 of via 720.

The arrangement of vias 702 of via layer 700 results in the B vias being closer to the nearest (or adjacent) A vias, thereby increasing the capacitive coupling between A and B vias, and thus, increasing capacitance density of the via layer 700. Additionally, by virtue of the opposing faces of the A and B vias being aligned substantially parallel to one another, the arrangement of a B via and an adjacent A via more closely resembles a parallel plate capacitor, further improving the capacitance density of the via layer 700. Thus, the BEOL capacitor structure using the via layer 700 of FIG. 7 achieves a higher intralayer capacitance for the via layers, thereby increasing the capacitance density of the BEOL capacitor structure. Furthermore, it should be noted that, although not illustrated in FIG. 7, if spacing and layout rules for the lower via layers allow for additional vias in via layer 700, the via layer 700 may be modified to include additional A vias aligned with the vertices of the quadrilateral-shaped regions 106 formed by the metallization pattern 102 (or otherwise aligned in the z-direction with the metallization pattern 102) and/or include additional B vias aligned in the z-direction with the metal landings 104 to achieve greater capacitance density for the via layer 700 and provide greater interlayer electrical interconnectivity (and thereby reducing series resistance of the capacitor structure). In this regard, if the via layer 700 includes additional B vias, additional A vias may be provided to align with the additional B vias in the x- and/or y-reference directions.

FIG. 9 depicts a top view of an exemplary embodiment of a metal layer 900 suitable for use as one or more lower metal layers in a BEOL capacitor structure using the via layer 700 of FIG. 7. In the illustrated embodiment, the metallization pattern 902 provides an interconnection between the A subset of vias 702 along the edges of the quadrilateral-shaped regions 106, resulting in the interior angles of the quadrilateral-shaped regions 106 that may be unequal to 90°. As shown, the metal layer 900 includes metal landings 904 disposed within quadrilateral regions formed by the metallization pattern 902 and aligned with overlying and/or underlying B vias to form vertical conductive structures that are interconnected by the metallization pattern 402 of the upper metal layer as described above.

FIG. 10 depicts a top view of an exemplary metal layer 1000 suitable for use as the upper metal layer in lieu of metal layer 400 in a BEOL capacitor structure in accordance with another embodiment. In this regard, when layout and/or spacing rules for the uppermost metal layer (e.g., Metal Layer 5) prevent the use of the metallization pattern 402 and/or metal landings 404 with the required dimensions and/or spacing to properly align with the vertical conductive structures formed by the underlying layers without increasing the spacing (or decreasing the capacitance density) of the lower metal layers, metal layer 1000 may be used to form an intralayer electrical interconnection among the vertical conductive structures for the B electrode. For example, in practice, the uppermost metal layer may be used for power and/or ground distribution, and to maintain low series resistance, the thickness of the uppermost metal layer may be greater than the lower metal layers, which in turn, may increase the minimum metal spacing for lines of metal in the uppermost metal layer.

As shown in FIG. 10, the metal layer 1000 includes a first metallization pattern 1002 corresponding to the B electrode of the capacitor and a second metallization pattern 1004 corresponding to the A electrode of the capacitor. The first metallization pattern 1002 comprises a plurality of metal fingers 1006 having longitudinal axes oriented in a first direction (e.g., oriented in the y-direction) that are interconnected along one end by the metallization pattern 1002 to form a comb-like structure. The second metallization pattern 1004 comprises a plurality of metal fingers 1008 having longitudinal axes that are oriented parallel to the metal fingers 1006 of the first metallization pattern 1002 (e.g., oriented in the y-direction) that are interconnected at the opposing end of the fingers 1008 by the metallization pattern 1004 to form a second comb-like structure. The metal fingers 1006, 1008 of the metallization patterns are interdigitated, that is, the metal fingers 1006, 1008 alternate between the A electrode and the B electrode across the metal layer 1000 in the x-direction.

In an exemplary embodiment, the metal fingers 1006 corresponding to the B electrode are arranged in the x- and y-directions such that they are aligned in the z-direction to overlie the B vias of the underlying via layer and the metal fingers 1008 corresponding to the A electrode are oriented in the x- and y-directions parallel to the metal fingers 1006 and such that the metal fingers 1008 aligned in the z-direction to overlie the A vias of the underlying via layer. In this regard, when the metal layer 1000 is used in combination with metal layer 100 and via layer 200 of FIGS. 1-3 and 5-6, the metal fingers 1006 are arranged such that the metal fingers 1006 overlie the vertical conductive structures corresponding to the B electrode. In this manner, the metallization pattern 1002 provides an intralayer interconnection for the B electrode of the capacitor. If the layout and/or spacing rules prevent the metal fingers 1006, 1008 from being aligned overlying the appropriate vias of the underlying via layer, the metal fingers 1006 may be externally connected to the metal landings of the underlying metal layer 100 (e.g., metal landings 104 of Metal Layer 4) and/or the metal fingers 1008 may be externally connected to the metallization pattern of the underlying metal layer (e.g., metallization pattern 102 of Metal Layer 4).

One advantage of using the metal layer 1000 in lieu of metal layer 400 as an uppermost layer of a BEOL capacitor structure is that, when layout and/or spacing rules for the uppermost metal layer (e.g., Metal Layer 5) prevent the use of the metallization pattern 402 and/or metal landings 404 with the required dimensions and/or spacing to properly align with the vertical conductive structures formed by the underlying layers, the metal layer 1000 provides relatively high intralayer capacitance without requiring an increase in the spacing (and thereby a reduction in the capacitance density) of the lower metal layers. Additionally, the interdigitated comb structure provides intralayer interconnectivity among the metal fingers 1006, 1008 of the same electrode to reduce the series resistance of metal layer 1000.

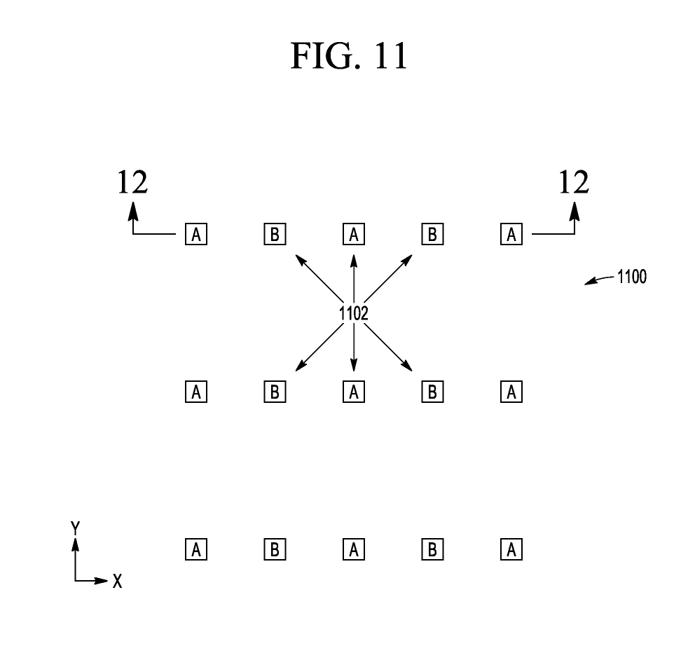

FIG. 11 depicts a top view of an exemplary embodiment of a via layer 1100 comprising a plurality of vias 1102 suitable for use with the metal layer 1000 of FIG. 10 as an underlying via layer (e.g., Via Layer 4) in the BEOL capacitor structure. In this regard, vias 1102 of the via layer 1100 are in contact with a metallization pattern 1002, 1004 of metal layer 1000. As described above, the metallization pattern 1002 provides an intralayer electrical interconnection between a first subset of the vias 1102 (the B subset of vias 1102) that are in contact with and underlying the metallization pattern 1002 and metallization pattern 1004 provides an intralayer electrical interconnection between a second subset of the vias 1102 (the A subset of vias 1102) that are in contact with and underlying the metallization pattern 1004. The vias 1102 are arranged such that A and B vias are aligned such that opposing faces of the A and B vias are substantially parallel to each other, as described above in the context of FIG. 7. In this regard, the via layer 1100 may provide increased capacitance density for the via layer (e.g., Via Layer 4) underlying the uppermost metal layer (e.g., Metal Layer 5).

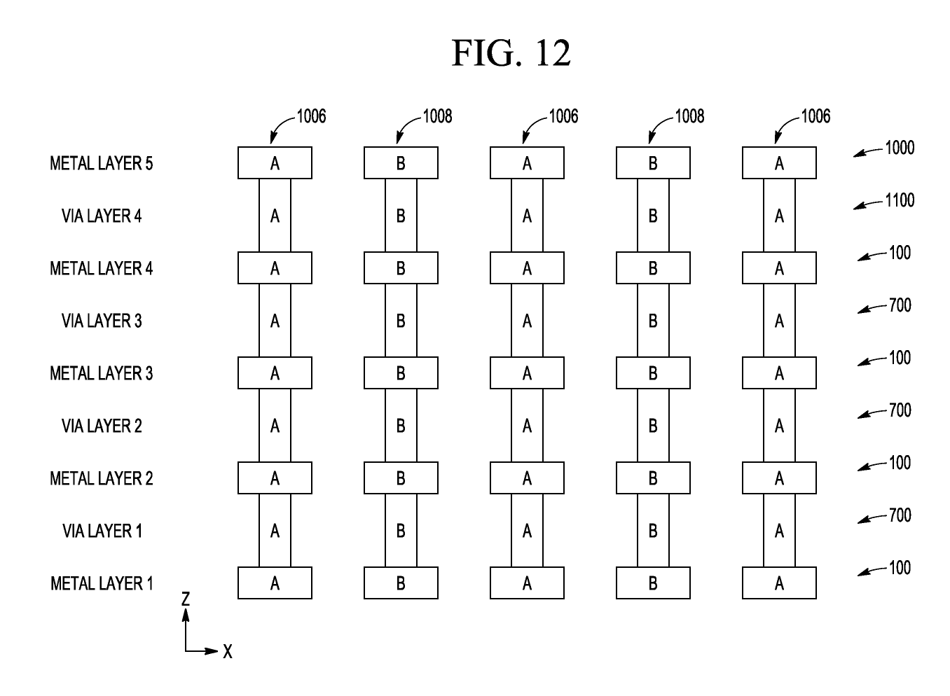

Referring now to FIG. 12, to potentially increase intralayer capacitance for the via layers (e.g., Via Layers 1 through 4) and the metal layers (e.g., Metal Layers 1 through 5), metal layer 1000 and via layer 1100 may be utilized with metal layer 100 of FIG. 1 and via layer 700 of FIG. 7. One advantage of the illustrated embodiment of FIG. 12 is that the relatively high intralayer capacitance of the via layers may be combined with lower metal layers capable of achieving relatively high intralayer capacitance and relatively high intralayer electrical interconnectivity for the A electrode of the capacitor structure while the uppermost metal layer provides relatively high intralayer capacitance and intralayer electrical interconnectivity without reducing the capacitance density of the underlying layers.

In the illustrated embodiment, the arrangement of via layer 700 overlying metal layer 100 described above is repeated (or stacked) to provide the lower metal layers (e.g., Metal Layers 1 through 4) and lower via layers (e.g., Via Layers 1 through 3) of a BEOL capacitor structure. The via layer 1100 is formed overlying the metal layer (e.g., Metal Layer 4) beneath the uppermost metal layer (e.g., Metal Layer 5). As shown, in an exemplary embodiment, the via layer 1100 is arranged such that the A vias of the via layer 1100 are aligned in the z-direction with corresponding A vias of the lower via layers (e.g., Via Layers 1 through 3) and the B vias of the via layer 1100 are aligned in the z-direction with corresponding metal landings 104 of the metal layer underlying the via layer 1100 (e.g., Metal Layer 4). Thus, the B vias are also aligned in the z-direction with the B vias of the lower via layers (e.g., Via Layers 1 through 3). In this manner, the arrangement of the metallization patterns 102 of the lower metal layers (e.g., Metal Layers 1 through 4), the A vias of the lower via layers (e.g., Via Layers 1 through 3), the A vias of the upper via layer (e.g., Via Layer 4), and the metal fingers 1008 of the uppermost metal layer (e.g., Metal Layer 5) create vertical conductive structures for the A electrode of the capacitor, wherein the metallization patterns 102, 1004 provide intralayer electrical interconnections for the vertical conductive structures to reduce series resistance of the A electrode. In this regard, the A electrode has intralayer electrical interconnectivity on each metal layer of the capacitor structure. Similarly, the arrangement of the metal landings 104 of the lower metal layers (e.g., Metal Layers 1 through 4), the B vias of the lower via layers (e.g., Via Layers 1 through 3), the B vias of the upper via layer (e.g., Via Layer 4), and the metal fingers 1006 of the uppermost metal layer (e.g., Metal Layer 5) create vertical conductive structures for the B electrode of the capacitor, wherein the metallization pattern 1002 provides an intralayer electrical interconnection for the vertical conductive structures to reduce series resistance of the B electrode.

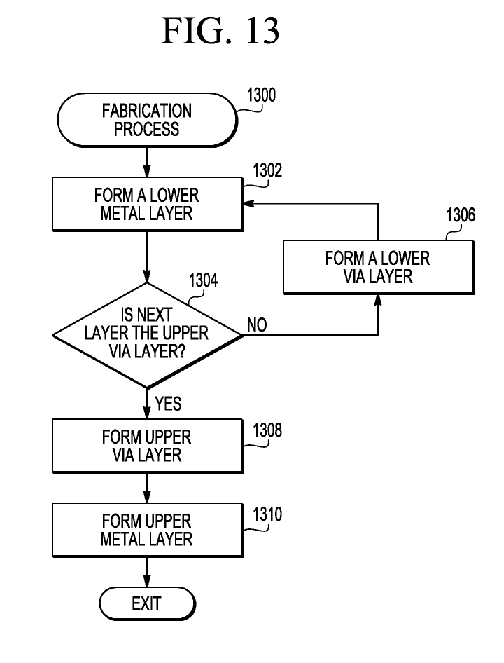

FIG. 13 illustrates a fabrication process 1300 for forming a BEOL capacitor structure. The fabrication process 1300 begins by forming a lower metal layer (task 1302). In this regard, the fabrication process 1300 may begin by forming the lowest metal layer of the BEOL capacitor structure (e.g., Metal Layer 1) by depositing a layer of conductive material overlying an interlayer dielectric and selectively removing portions of the conductive material to provide a metallization pattern and metal landings. When the next layer does not correspond to the upper via layer, the fabrication process 1300 continues by forming a lower via layer overlying the first metal layer (tasks 1304, 1306). In this regard, the fabrication process 1300 forms a lower via layer by forming a layer of dielectric material overlying the first metal layer, patterning and etching holes in the layer of dielectric material, and forming a conductive material in the holes in the dielectric material resulting in plurality of vias aligned with the metallization pattern or the metal landings of the underlying metal layer. In an exemplary embodiment, the fabrication process 1300 repeats the loop defined by tasks 1302, 1304, and 1306 until the next layer to be formed corresponds to the upper via layer. When the next layer corresponds to the upper via layer, the fabrication process 1300 forms an upper via layer by forming a layer of dielectric material overlying a metal layer, patterning and etching holes in the layer of dielectric material, and forming a conductive material in the holes in the dielectric material resulting a plurality of vias aligned with the metal landings of the underlying metal layer, as described above (task 1308). The fabrication process 1300 continues by forming an upper metal layer by conformably depositing a layer of conductive material overlying the upper via layer and selectively removing portions of the conductive material to form a metallization pattern configured to provide an intralayer electrical connection between the vias of the upper via layer that are aligned with the metal landings of the underlying metal layer, as described above (task 1310).

Apparatus configured in accordance with example embodiments of the invention and related fabrication methods relate to:

In accordance with one embodiment, an apparatus is provided for a capacitor structure. The capacitor structure comprises a plurality of metal layers, the plurality of metal layers comprising a plurality of consecutive metal layers and a first metal layer, wherein the plurality of consecutive metal layers form a plurality of vertically-aligned enclosed regions. The capacitor structure further comprises a plurality of via layers, wherein each via layer of the plurality of via layers is interposed between metal layers of the plurality of metal layers. The plurality of metal layers and the plurality of via layers are cooperatively configured to provide a first plurality of vertical conductive structures corresponding to a first electrode of a capacitor and a second plurality of vertical conductive structures corresponding to a second electrode of the capacitor. Each metal layer of the consecutive metal layers provides intralayer electrical interconnections among the first plurality of vertical conductive structures. The first metal layer provides an intralayer electrical interconnection among the second plurality of vertical conductive structures, wherein each vertically-aligned enclosed region has a vertical conductive structure of the second plurality of vertical conductive structures disposed therein. In one embodiment, the plurality of consecutive metal layers comprise a plurality of lower metal layers and the first metal layer comprises an upper metal layer. In another embodiment, the first metal layer forms a second plurality of enclosed regions, each enclosed region of the second plurality of enclosed regions having an interior having a vertical conductive structure of the first plurality of vertical conductive structures disposed therein. In yet another embodiment, the first metal layer forms a second plurality of enclosed regions, each enclosed region of the second plurality of enclosed regions having a metal landing electrically connected to the first plurality of vertical conductive structures disposed therein. In accordance with another embodiment, one or more via layers are configured such that each vertical face of each via of a vertical conductive structure of the second plurality of vertical conductive structures is substantially parallel to a vertical face of an adjacent via of a vertical conductive structure of the first plurality of vertical conductive structures. In another embodiment, the second plurality of vertical conductive structures are not interconnected by the lower metal layers.

Another embodiment of a capacitor structure comprises a first metal layer, a first via layer, a second metal layer, a second via layer, and a third metal layer. The first metal layer comprises a first metallization pattern and a first plurality of metal landings, the first metallization pattern forming one or more regions, wherein a metal landing of the first plurality of metal landings is disposed within a respective region of the one or more regions formed by the first metallization pattern. The first via layer overlies the first metal layer, and the first via layer includes a first subset of vias in contact with the first metallization pattern and a second subset of vias in contact with the first plurality of metal landings. The second metal layer overlies the first via layer and comprises a second metallization pattern in contact with the first subset of vias and a second plurality of metal landings in contact with the second subset of vias. The second metallization pattern forms one or more regions vertically-aligned with the one or more regions formed by the first metallization pattern, wherein a metal landing of the second plurality of metal landings is disposed within each respective region of the one or more regions formed by the second metallization pattern. The second via layer overlies the second metal layer, and the second via layer includes a third subset of vias in contact with the second plurality of metal landings. The third metal layer overlies the second via layer, and the third metal layer comprises a third metallization pattern configured to provide an intralayer electrical interconnection among the third subset of vias.

In accordance with one embodiment, the second via layer includes a fourth subset of vias in contact with the second metallization pattern, and the third metal layer comprises a third plurality of metal landings in contact with the fourth subset of vias, the third metallization pattern forming one or more regions, wherein a metal landing of the third plurality of metal landings is disposed within each respective region of the one or more regions formed by the third metallization pattern. In another embodiment, each metal landing of the first plurality of metal landings is overlying and aligned with a metal landing of the second plurality of metal landings. In a further embodiment, the first plurality of metal landings and the second plurality of metal landings form a plurality of vertical conductive structures corresponding to a first electrode. In one embodiment, the third metal layer provides an intralayer electrical interconnection among vertical conductive structures corresponding to the first electrode. In accordance with another embodiment, the second metallization pattern forms one or more quadrilateral-shaped regions, wherein each metal landing of the third plurality of metal landings overlies a vertex of a quadrilateral-shaped region of the one or more quadrilateral-shaped regions. In a further embodiment, each quadrilateral-shaped region of the one or more quadrilateral-shaped regions formed by the second metallization pattern is overlying and aligned with a quadrilateral-shaped region formed by the first metallization pattern. In yet another embodiment, the first metallization pattern forming one or more quadrilateral-shaped regions, wherein the first subset of vias includes a via overlying and aligned with each vertex of each quadrilateral-shaped region formed by the first metallization pattern. In one embodiment, the first via layer is configured such that each vertical face of each via of the second subset of vias are substantially parallel to a vertical face of a via of the first subset of vias.

In accordance with yet another embodiment, the second via layer includes a fourth subset of vias in contact with the second metallization pattern and the third metal layer comprises a fourth metallization pattern in contact with the fourth subset of vias. In a further embodiment, he third metallization pattern comprises a first plurality of metal fingers and the fourth metallization pattern comprises a second plurality of metal fingers. In one embodiment, the first plurality of metal fingers and the second plurality of metal fingers are interdigitated. In another embodiment, the third metallization pattern provides an interconnection among the first plurality of metal fingers at an end of the first plurality of metal fingers.

In another embodiment, a method for forming a capacitor structure is provided. The method comprises forming a first metal layer comprising a first metallization pattern and a first plurality of metal landings, forming a first via layer overlying the first metal layer, forming a second metal layer overlying the first via layer, forming a second via layer overlying the second metal layer, forming a third metal layer overlying the second via layer. The first metallization pattern forms a first plurality of enclosed regions, each region of the first plurality of enclosed regions having a metal landing of the first plurality of metal landings disposed therein. The first via layer includes a first subset of vias in contact with the first metallization pattern and a second subset of vias in contact with the first plurality of metal landings. The second metal layer comprises a second metallization pattern in contact with the first subset of vias and a second plurality of metal landings in contact with the second subset of vias. The second metallization pattern forms a second plurality of enclosed regions vertically-aligned with the first plurality of enclosed regions, each region of the second plurality of enclosed regions having a metal landing of the second plurality of metal landings disposed therein. The second via layer includes a third subset of vias in contact the second plurality of metal landings. The third metal layer comprises a third metallization pattern configured to provide an intralayer electrical interconnection among the third subset of vias.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A capacitor structure comprising:
a plurality of metal layers, the plurality of metal layers comprising a plurality of consecutive metal layers and a first metal layer;
a plurality of via layers, each via layer of the plurality of via layers being interposed between metal layers of the plurality of metal layers, wherein the plurality of metal layers and the plurality of via layers are cooperatively configured to provide:
a first electrode of a capacitor including a first plurality of vertical conductive structures, the first electrode comprising intralayer electrical interconnections among the first plurality of vertical structures at each metal layer of the consecutive metal layers, wherein intralayer electrical interconnections within each consecutive metal layer form enclosed regions resulting in a plurality of vertically-aligned enclosed regions formed by the plurality of consecutive metal layers; and
a second electrode of the capacitor including a second plurality of vertical conductive structures, wherein:
a vertical conductive structure of the second plurality of vertical conductive structures is disposed within each vertically-aligned enclosed region of the plurality of vertically-aligned enclosed regions; and
the first metal layer provides an intralayer electrical interconnection among the second plurality of vertical conductive structures.

2. The capacitor structure of claim 1, wherein the plurality of consecutive metal layers comprise a plurality of lower metal layers and the first metal layer comprises an upper metal layer.

3. The capacitor structure of claim 1, wherein the first metal layer forms a second plurality of enclosed regions, each region of the second plurality of enclosed regions having an interior having a vertical conductive structure of the first plurality of vertical conductive structures disposed therein.

4. The capacitor structure of claim 1, wherein the first metal layer forms a second plurality of enclosed regions, each enclosed region of the second plurality of regions having a metal landing electrically connected to the first plurality of vertical conductive structures disposed therein.

5. The capacitor structure of claim 1, wherein one or more via layers is configured such that each vertical face of each via of a vertical conductive structure of the second plurality of vertical conductive structures is substantially parallel to a vertical face of an adjacent via of a vertical conductive structure of the first plurality of vertical conductive structures.

6. The capacitor structure of claim 1, wherein the second plurality of vertical conductive structures are not interconnected by the consecutive metal layers.

7. A capacitor structure comprising:
a first metal layer comprising a first metallization pattern and a first plurality of metal landings, the first metallization pattern forming one or more regions, wherein a metal landing of
the first plurality of metal landings is disposed within a respective region of the one or more regions formed by the first metallization pattern;
a first via layer overlying the first metal layer, the first via layer including a first subset of vias in contact with the first metallization pattern and a second subset of vias in contact with the first plurality of metal landings;
a second metal layer overlying the first via layer, the second metal layer comprising a second metallization pattern in contact with the first subset of vias and a second plurality of metal landings in contact with the second subset of vias, the second metallization pattern forming one or more regions vertically-aligned with the one or more regions formed by the first metallization pattern, wherein a metal landing of the second plurality of metal landings is disposed within each respective region of the one or more regions formed by the second metallization pattern;
a second via layer overlying the second metal layer, the second via layer including a third subset of vias in contact with the second plurality of metal landings; and
a third metal layer overlying the second via layer, the third metal layer comprising a third metallization pattern configured to provide an intralayer electrical interconnection among the third subset of vias.

8. The capacitor structure of claim 7, wherein:
the second via layer includes a fourth subset of vias in contact with the second metallization pattern; and
the third metal layer comprises a third plurality of metal landings in contact with the fourth subset of vias, the third metallization pattern forming one or more regions, wherein a metal landing of the third plurality of metal landings is disposed within each respective region of the one or more regions formed by the third metallization pattern.

9. The capacitor structure of claim 8, wherein each metal landing of the first plurality of metal landings is overlying and aligned with a metal landing of the second plurality of metal landings.

10. The capacitor structure of claim 9, wherein the first plurality of metal landings and the second plurality of metal landings form a plurality of vertical conductive structures corresponding to a first electrode.

11. The capacitor structure of claim 10, wherein the third metal layer provides the intralayer electrical interconnection among vertical conductive structures corresponding to the first electrode.

12. The capacitor structure of claim 8, the second metallization pattern forming one or more quadrilateral-shaped regions, wherein each metal landing of the third plurality of metal landings overlies a vertex of a quadrilateral-shaped region of the one or more quadrilateral-shaped regions.

13. The capacitor structure of claim 12, wherein each quadrilateral-shaped region of the one or more quadrilateral-shaped regions formed by the second metallization pattern is overlying and aligned with a quadrilateral-shaped region formed by the first metallization pattern.

14. The capacitor structure of claim 7, the first metallization pattern forming one or more quadrilateral-shaped regions, wherein the first subset of vias includes a via overlying and aligned with each vertex of each quadrilateral-shaped region formed by the first metallization pattern.

15. The capacitor structure of claim 7, wherein the first via layer is configured such that each vertical face of each via of the second subset of vias are substantially parallel to a vertical face of a via of the first subset of vias.

16. The capacitor structure of claim 7, wherein
the second via layer includes a fourth subset of vias in contact with the second metallization pattern; and
the third metal layer comprises a fourth metallization pattern in contact with the fourth subset of vias.

17. The capacitor structure of claim 16, wherein the third metallization pattern comprises a first plurality of metal fingers and the fourth metallization pattern comprises a second plurality of metal fingers.

18. The capacitor structure of claim 17, wherein the first plurality of metal fingers and the second plurality of metal fingers are interdigitated.

19. The capacitor structure of claim 17, wherein the third metallization pattern provides an interconnection among the first plurality of metal fingers at an end of the first plurality of metal fingers.

20. A method for forming a capacitor structure, the method comprising:
forming a first metal layer comprising a first metallization pattern and a first plurality of metal landings, the first metallization pattern forming a first plurality of enclosed regions, each region of the first plurality of enclosed regions having a metal landing of the first plurality of metal landings disposed therein;
forming a first via layer overlying the first metal layer, the first via layer including a first subset of vias in contact with the first metallization pattern and a second subset of vias in contact with the first plurality of metal landings;
forming a second metal layer overlying the first via layer, the second metal layer comprising a second metallization pattern in contact with the first subset of vias and a second plurality of metal landings in contact with the second subset of vias, the second metallization pattern forming a second plurality of enclosed regions vertically-aligned with the first plurality of enclosed regions, each region of the second plurality of enclosed regions having a metal landing of the second plurality of metal landings disposed therein;
forming a second via layer overlying the second metal layer, the second via layer including a third subset of vias in contact the second plurality of metal landings; and
forming a third metal layer overlying the second via layer, the third metal layer comprising a third metallization pattern configured to provide an intralayer electrical interconnection among the third subset of vias.
